(19) United States
(12) Patent Application Publication
(10) Pub. No.: US 2022/0179927 A1
(43) Pub. Date: Jun. 9, 2022

(54) VERIFYING METHOD FOR SOFTWARE AUTHORIZATION UNDER OFFLINE ENVIRONMENT

(71) Applicant: Delta Electronics, Inc., Taoyuan City (TW)

(72) Inventors: Hung-Hsueh TAI, Taoyuan City (TW); Yu-Qiao HONG, Taoyuan City (TW); Jia-Hong PENG, Taoyuan City (TW)

(21) Appl. No.: 17/346,201

(22) Filed: Jun. 12, 2021

(30) Foreign Application Priority Data
Dec. 9, 2020 (CN) 202011450035.7

(51) Int. Cl. G06F 21/12; G06F 21/44

(52) U.S. Cl. CPC G06F 21/121; G06F 2221/0775; G06F 21/44

(57) ABSTRACT

A verifying method for software authorization under an offline environment is disclosed. The method includes: executing an application software in an electronic device; obtaining a serial number to input to the application software; decrypting the serial number to at least retrieve a requested using term, and a hard-drive identification time information of a hard-drive of the electronic device recorded at the time the serial number being applied; obtaining a power-on time of the hard-drive of the electronic device; computing a using time of the application software in the electronic device according to the hard-drive identification time information and the power-on time; determining whether an authorization to the application software is expired according to the using time and the requested using term; and disabling the application software if the authorization to the application software is expired.

### BACKGROUND OF THE INVENTION

### 1. Technical Field

The technical field relates to a verifying method, and specifically relates to a verifying method for an authorization term of software.

### 2. Description of Related Art

In order to get a computer capable of executing certain functions, software is installed to the computer. For preventing the software from being used abusedly, such as unauthorized duplication, unlimited usage, etc., the software provider usually sets an authorization using term to each software. When the software is executed by the computer, a verification framework is applied to verify the authorization using term of the software, and the software is forbidden to be run in the computer if the authorization using term is expired.

Most of the softwares in the market are usually applied with an online verification framework. In particular, the online verification framework uses a remote server to obtain the information of the software when the software is executed, and the remote server verifies whether the authorization to the software is expired according to the obtained information. However, for those computers being used in the environments without an Internet connection (such as, in the factories), the aforementioned online verification framework cannot be implemented.

A related verification framework designed for the offline environments is implemented through a hardware lock. In particular, when a software is executed by a computer, the computer first reads essential data from the hardware lock (usually is a USB Dongle) connected therewith, and allows the software to be activated if the essential data is correctly obtained. However, the usage of the hardware lock needs additional hardware and increases the verification cost. Also, once the user obtains the hardware lock, the software may be used unlimitedly, which is harmful to the software providers.

Besides, a part of the software providers provide another verification framework by using software lock. In particular, the verification framework of the software lock needs to write specific data to the file system of the computer as a foundation for verifying the software run in the computer. However, once the specific data in the file system is retrieved by the people with bad intentions, the specific data may be modified (for example, modifies the using term recorded in the specific data), and then the verification framework with the software lock may be made to be invalid.

According to the reasons stated above, a novel verifying method which may be used under the offline environments and difficult to be cracked is urgent needed in the technical field.

### SUMMARY OF THE INVENTION

This disclosure is directed to a verifying method for software authorization under an offline environment, which may verify the authorized term of the software without connecting to the Internet, using an additional hardware, or writing additional data to an electronic device.

In one of the exemplary embodiments, the verifying method in this disclosure includes following steps: executing an application software in an electronic device; obtaining a serial number and inputting the serial number to the application software; decrypting the serial number to at least retrieve a requested using term, and a hard-drive identification time information of a hard-drive of the electronic device recorded at the time the serial number being applied; obtaining a power-on time of the hard-drive; computing a using time of the application software in the electronic device according to the hard-drive identification time information and the power-on time; determining whether an authorization to the application software is expired according to the using time and the requested using term; and disabling the application software if the authorization to the application software is expired.

In comparison to the related art, this disclosure may verify the authorized term of the software under the offline environments without using an additional hardware or writing additional data to the electronic device. This disclosure reduces the cost for verification under the offline environments and the probability of the software being cracked.

### DESCRIPTION OF THE DRAWINGS

FIG. 1 is a schematic diagram of a system of an embodiment according to this disclosure.

FIG. 2 is a flowchart for generating an application code of an embodiment according to this disclosure.

FIG. 3A is a diagram representing an application of a serial number of an embodiment according to this disclosure.

FIG. 3B is a diagram representing a generation of the application code of an embodiment according to this disclosure.

FIG. 4 is a flowchart for generating the serial number of an embodiment according to this disclosure.

FIG. 5 is a flowchart for a verification of an embodiment according to this disclosure.

FIG. 6A is a flowchart showing a first part of the verification according to this disclosure.

FIG. 6B is a flowchart showing a second part of the verification according to this disclosure.

### DETAILED DESCRIPTION OF THE INVENTION

In cooperation with the attached drawings, the technical contents and detailed description of this disclosure are described thereinafter according to multiple embodiments, being not used to limit its executing scope. Any equivalent variation and modification made according to appended claims is all covered by the claims claimed by this disclosed.

This disclosure relates to a verifying method for software authorization under the offline environments (refers to as the verifying method hereinafter). The verifying method is incorporated with different types of electronic device, such as a personal computer (PC), a laptop, a server, an industrial PC (IPC), an intellectual mobile device, etc., so as to assist the electronic device to perform an verification action (or process) under an offline environment for an application software installed therein to verify whether an authorized term of the application software is expired.

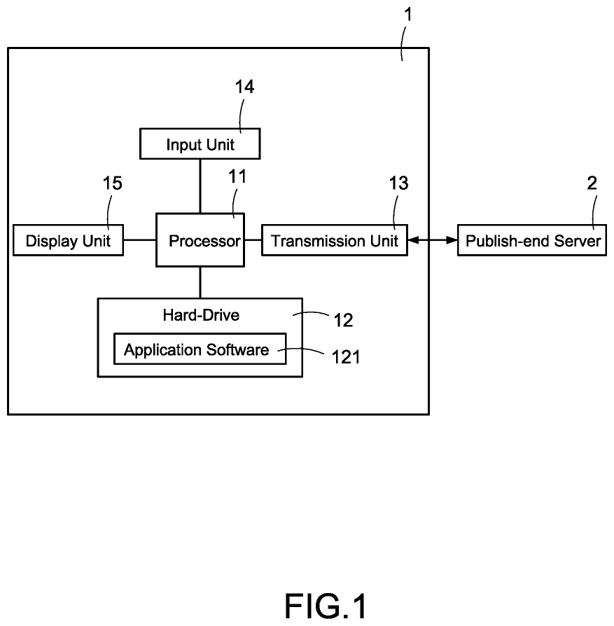

FIG. 1 is a schematic diagram of a system of an embodiment according to this disclosure. The verifying method of this disclosure is incorporated with an electronic device 1 as shown in FIG. 1, the electronic device 1 at least includes a processor 11, a hard-drive 12, and a transmission unit 13. The hard-drive 12 and the transmission unit 13 are electrically connected with the processor 11. A user may install an application software 121 to the hard-drive 12 of the electronic device 1, so that the electronic device 1 may execute the application software 121 through the processor 11. When the application software 121 is executed by the processor 11 for the first time, the electronic device 1 transmits an application code for applying a serial number of the application software 121 to a publish-end server 2 through the transmission unit 13, and the electronic device 1 may receive the serial number corresponding to the application software 121 generated and replied from the publish-end server 2. In this disclosure, when the electronic device 1 receives the serial number and inputs the serial number to the application software 121, the application software 121 may perform an offline verification action according to the content of the serial number.

The publish-end server 2 is a server managed by a software provider who develops and provides the application software 121. The software provider has the authority to set the authorization of the application software 121, so that the publish-end server 2 may be implemented to generate and provide the serial number used for activating the application software 121. One technical feature of this disclosure is that the serial number generated by the publish-end server 2 includes the effective information that allows the application software 121 to perform a verification action under the offline environments.

It should be mentioned that the transmission unit 13 may be a wireless transmission unit such as a telecommunication transmission unit, a Wi-Fi transmission unit, a Bluetooth transmission unit, a Zigbee transmission unit, a near field communication (NFC) transmission unit, etc., or a wired transmission unit such as an USB transmission unit, but not limited thereto. In this disclosure, a user may install the application software 121 to the electronic device 1, and move and use the electronic device 1 in an offline environment (such as a factory) after the serial number corresponding to the application software 121 is obtained. Under such scenario, the application software 121 may perform the offline verification action according to the content of the serial number, so as to prevent the application software 121 from being used unlimitedly in case that the using time of the application software 121 exceeds the original authorized term.

It is noted that the application software 121 in this disclosure may record the obtained serial number. Each time the electronic device 1 executes the application software 121, the application software 121 performs the offline verification action once according to the content of the serial number, so the authorized term of the application software 121 may be effectively traced.

In one of the exemplary embodiments, the electronic device 1 includes an input unit 14 electrically connected with the processor 11. The input unit 14 may be, for example, a keyboard, a mouse, a touch screen, etc., but not limited thereto. In this embodiment, the user may input essential data needed for applying the serial number of the application software 121 through the input unit 14 (detail described below), and the user may submit an application request for the serial number to the publish-end server 2 through the input unit 14.

In one of the exemplary embodiments, the electronic device 1 includes a display unit 15 electrically connected with the processor 11. The display unit 15 may be, for example, a liquid crystal display (LCD), a touch screen, etc., but not limited thereto. In this embodiment, the electronic device 1 may display relative windows through the display unit 15 for guiding the user to provide such essential data through the windows.

As mentioned above, this disclosure submits the application request to the publish-end server 2 to apply the serial number that corresponds to the application software 121 through a wireless or wired manner, and the publish-end server 2 may generate and transmit the serial number correspondingly. In one of the exemplary embodiments, the electronic device 1 generates an application code according to the essential data, and transmits the generated application code to the publish-end server 2 for applying the serial number. For example, the electronic device 1 may transmit the application code to the publish-end server 2 through an e-mail, a text message, a fax, etc., but not limited thereto.

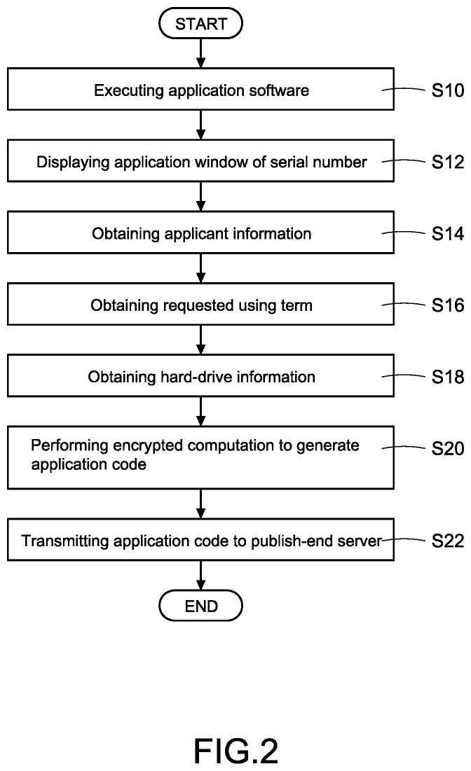

Please refer to FIG. 1 through FIG. 2, wherein FIG. 2 is a flowchart for generating an application code of an embodiment according to this disclosure. First, a user installs the applications software 121 to the electronic device 1, and the electronic device 1 executes the application software 121 after the installation is completed (step S10). In this disclosure, the application software 121 displays an application window of the serial number on the display unit 15 of the electronic device 1 after being executed for the first time (step S12). Next, the user may follow the guidance of the application window to operate the input unit 14 of the electronic device 1 and input relative data, so the application software 121 may obtain the data such as an applicant information (step S14) and a requested using term needed by the user (step S16).

In order to determine whether an authorized term of the application software 121 is expired under the offline environment, one technical feature of this disclosure is that the application software 121 may send a request to the electronic device 1 for obtaining a hard-drive information of the hard-drive 12 arranged in the electronic device 1 (step S18).

In one of the exemplary embodiments, the applicant information may be, for example, the name, the e-mail, the telephone number, etc., of the applicant (such as the instant user of the electronic device 1), but not limited thereto. The requested using term may be a length of time (such as one year, two years, etc.) or an authorization expiring date (such as Dec. 31, 2021). In this embodiment, the user may select the requested using term according to an authorization rule or an authorization fee of the application software 121. The hard-drive information may be the information of the hard-drive 12 arranged in the electronic device 1 at the very time. In this embodiment, the hard-drive information at least includes a hard-drive identification time information of the hard-drive 12 recorded at the time when the user submitted the application request for the serial number.

In one of the exemplary embodiments, the application software 121 requests the electronic device 1 in the step S18 for a record of self-monitoring analysis and reporting technology (S.M.A.R.T) data, and uses the power-on hours of the hard-drive 12 recorded in the S.M.A.R.T data as the hard-drive identification time information. In this disclosure, the application software 121 records the hard-drive identification time information in the application code used for applying the serial number (detail described below). Therefore, when the offline verification action is performed, the application software 121 may use the hard-drive identification time information as an absolute time, which indicates a time point when the application software 121 is executed on the electronic device 1 for the first time.

It should be mentioned that, the hard-drive information obtained by application software 121 in the step S18 may further include a unique device identifier (UDID) of the electronic device 1 for binding the application software 121 to the electronic device 1 and preventing the application software 121 from unauthorizedly duplicating to other electronic devices. In particular, the UDID may be a UDID of the hard-drive 12 used by the electronic device 1. By adding the UDID of the hard-drive 12 to the application code, when the application software 121 obtains the serial number, the application software 121 may determine whether the hard-drive 12 arranged in the electronic device 1 is changed with respect to the UDID recorded in the serial number (detail described below).

Next, the application software 121 performs an encrypted computation for the applicant information, the requested using term, and the hard-drive information to generate an application code (step S20). In one of the exemplary embodiments, the application software 121 may perform the encrypted computation to generate the application code by using an advanced encryption standard (AES) algorithm. The generated application code may be in a manner of a random number string including uppercase letters, lowercase letters, numbers, symbols, etc., but not limited thereto.

In this disclosure, the purpose of generating and transmitting the application code is for the publish-end server 2 to generate a corresponding serial number, hence the application code may be unencrypted if the application code correctly carries the essential data. For example, the application software 121 may directly combine the applicant information, the requested using term, and the hard-drive information mentioned above as a single string to save the computing resources of the electronic device 1.

After the step S20, the application software 121 transmits the application code to the publish-end server 2 through the transmission unit 13 of the electronic device 1 (step S22). After the application code is received, the publish-end server 2 may generate a serial number that corresponds to the application software 121 according to the content of the application code. In this disclosure, the serial number may only be used by the application software 121 and the electronic device 1 that generate the application code. In other words, the serial number is a unique serial number.

In one of the exemplary embodiments, the application software 121 may transmit the application code to the publish-end server 2 in the step S22 through a wireless transmission unit 13 by way of e-mails, text messages, Bluetooth transmissions, Zigbee transmissions, Wi-Fi transmissions, etc. In another embodiment, the electronic device 1 connects with the publish-end server 2 through a wired transmission unit 13 such as an USB cable, and the application software 121 may transmit the application code to the publish-end server 2 in the step S22 through the wired manners. The above descriptions are only few embodiments of this disclosure, not intended to limit the scope of the invention.

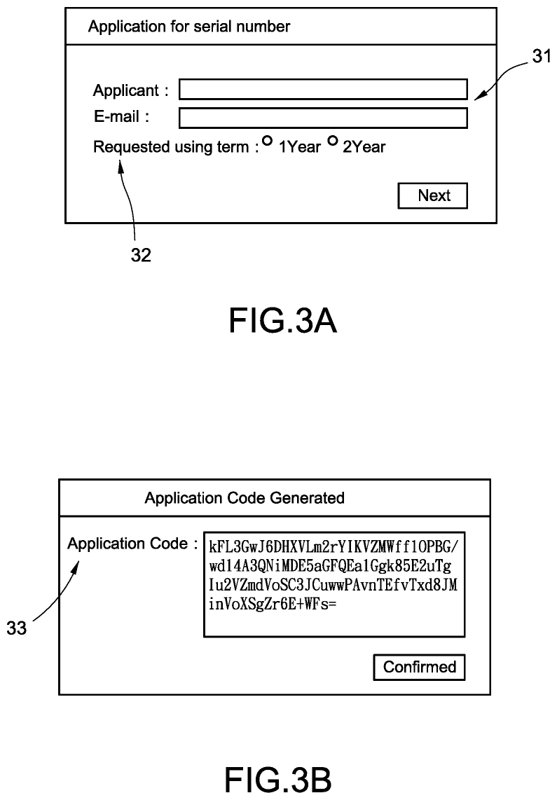

Please refer to FIG. 1 through FIG. 3A and FIG. 3B, wherein FIG. 3A is a diagram representing an application of a serial number of an embodiment according to this disclosure, and FIG. 3B is a diagram representing a generation of the application code of an embodiment according to this disclosure.

As shown in FIG. 3A, when the user operates the electronic device 1 to execute the application software 121 for the first time, the user needs to apply for the serial number. At this time, the application software 121 may display an application window through the display unit 15 of the electronic device 1. On this application window, the user may input the applicant information 31 and select the requested using term 32 through the input unit 14.

In the embodiment of FIG. 3A, the applicant information 31 uses the name and the e-mail of the applicant as an example, and the requested using term 32 uses a length of time (one year or two years) as an example, here is not intended to be limiting. In another embodiment, the applicant information 31 may include date of birth, telephone number, ID number of the applicant, and the requested using term 32 may be a specific authorization expiring date.

In addition to the applicant information 31 and the requested using term 32, the application software 121 may also send a request to the electronic device 1 for obtaining an application data like the hard-drive information of the hard-drive 12 (such as the UDID and the power-on hours) and a system time of the electronic device 1. As shown in FIG. 3B, after an encrypted computation is performed to the application data, the application software 121 may generate an application code 33 involving random numbers, or characters, or symbols, or combined. In this disclosure, the application code 33 generated by the application software 121 includes all the aforementioned information such as the applicant information 31, the requested using term 32, the hard-drive information, the system time, etc.

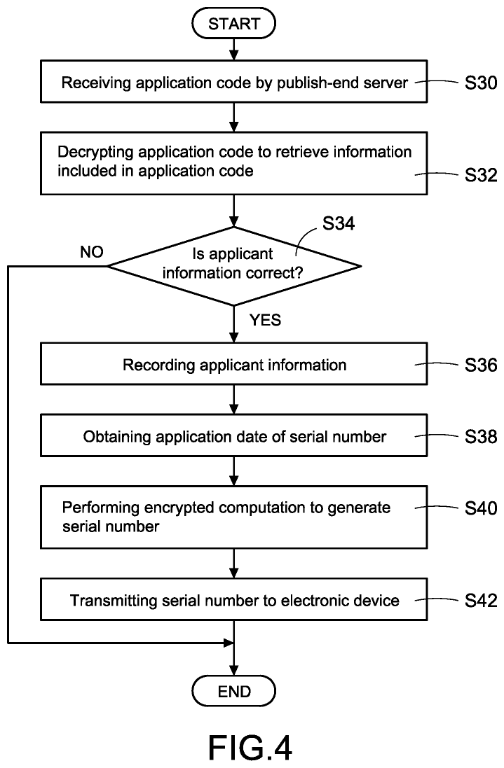

Please refer to FIG. 1 through FIG. 4, wherein FIG. 4 is a flowchart for generating the serial number of an embodiment according to this disclosure. The publish-end server 2 in this disclosure is an online/offline server managed by the software provider developing and providing the application software 121, and the publish-end server 2 may receive the application code 33 transmitted from the user-end electronic device 1 through an embedded transmission unit (not shown in figures) (step S30).

After receiving the application code 33, the publish-end server 2 decrypts the application code 33 to retrieve all the information included in the application code 33 (step S32). In this disclosure, the publish-end server 2 may use an algorithm to decrypt the application code 33 similar to the algorithm used by the electronic device 1 in the step S20 as shown in FIG. 2. The data retrieved by the publish-end server 2 after decrypting the application code 33 is the same with the data used by the application software 121 for generating the application code 33 in the step S20. In one of the exemplary embodiments, the publish-end server 2 may obtain data such as the applicant information 31, the requested using term 32, the hard-drive information (including the hard-drive identification time information, the UDID), etc., after decrypting the application code 33, but not limited thereto.

After the step S32, the publish-end server 2 first determines whether the applicant information 31 is correct (step S34). In particular, the publish-end server 2 determines, in the step S34, whether the applicant's name is correct (such as to check if a purchased record for the application software 121 exists under the applicant's name), and whether the applicant's e-mail address is correct (such as to send a confirming letter to the applicant's e-mail address and require the applicant to verify the e-mail address), but not limited thereto. If the applicant information 31 is incorrect, the publish-end server 2 does not generate the serial number of the application software 121 and transmits a warning message to the electronic device 1 or the applicant's e-mail address. If the applicant information 31 is correct, the publish-end server 2 records the applicant information 31 (step S36), such as to write the applicant information 31 to a database (not shown in figures).

The above description is only one of the exemplary embodiments of this disclosure. In another embodiment, the publish-end server 2 may omit the step of determining the correctness of the applicant information 31, and may omit the step of recording the applicant information 31.

In one of the exemplary embodiments, the publish-end server 2 further obtains an application date of the serial number (step S38). In particular, the publish-end server 2 obtains, in the step S38, the system time of the publish-end server 2 at the very time such as the standard time of the operating system (OS), or the time of the basic input/output system (BIOS), and the publish-end server 2 regards the system time as the application date that the user requests for the serial number. More specifically, the application date is the date that the publish-end server 2 receives the application code 33, and is the date that the publish-end server 2 generates the serial number of the application software 121.

As mentioned above, the electronic device 1 generates and transmits the application code 33 when the electronic device 1 executes the application software 121 for the first time. As a result, the application date may be regarded as an absolute time, which indicates the time point when the application software 121 is executed on the electronic device 1 for the first time. However, comparing to the other information recorded in the application code 33 such as the hard-drive identification time information, the application date is less accurate (because the system time may easily be modified), the step S38 may not be a necessary step to be executed.

Next, the publish-end server 2 performs another encrypted computation for the obtained data, so as to generate the serial number that exclusively belongs to the application software 121 (step S40). It should be mentioned that in the step S40, the publish-end server 2 uses an algorithm to perform the encrypted computation different from the algorithm used by the application software 121 in the step S20 as shown in FIG. 2.

Next, the publish-end server 2 transmits the generated serial number to the user-end electronic device 1 through wired or wireless transmitting manner (step S42), so that the user may input the serial number to the application software 121 to activate the application software 121.

In one of the exemplary embodiments, the application code generated by the application software 121 includes the applicant information 31, the requested using term 32, and the hard-drive information. In the step S40, the publish-end server 2 performs the encrypted computation for the requested using term 32 and the hard-drive information to generate the serial number. In this embodiment, the hard-drive information may only include the hard-drive identification time information of the hard-drive 12 (i.e., the power-on hours), or the hard-drive information may include both the hard-drive identification time information and the UDID.

In another embodiment, after the publish-end server 2 receives and decrypts the application code 33, the publish-end server 2 obtains the system time of the publish-end server 2 and uses it as the application date of the serial number. In the step S40, the publish-end server 2 performs the encrypted computation for the requested using term 32, the application date, and the hard-drive information to generate the serial number.

In another embodiment, the requested using term 32 selected by the user is a length of time. Before the serial number is generated, the publish-end server 2 computes an authorization expiring date (such as Jan. 1, 2022) according to the application date (such as Jan. 1, 2020) and the requested using term 32 (such as two years). In this embodiment, the publish-end server 2 performs the encrypted computation for the requested using term 32, the authorization expiring date, and the hard-drive information to generate the serial number. In other words, the content of the generated serial number directly includes the authorization expiring date of the application software 121.

In this disclosure, the application software 121 generates the application code 33 according to the information of the electronic device 1 recorded at the time the user requested for the serial number, and the publish-end server 2 generates the serial number that exclusively belongs to the application software 121 according to the content of the application code 33. As a result, after the serial number from the publish-end server 2 is received, the application software 121 may perform the verification action for determining whether the authorized term to the application software 121 is expired according to the content of the serial number.

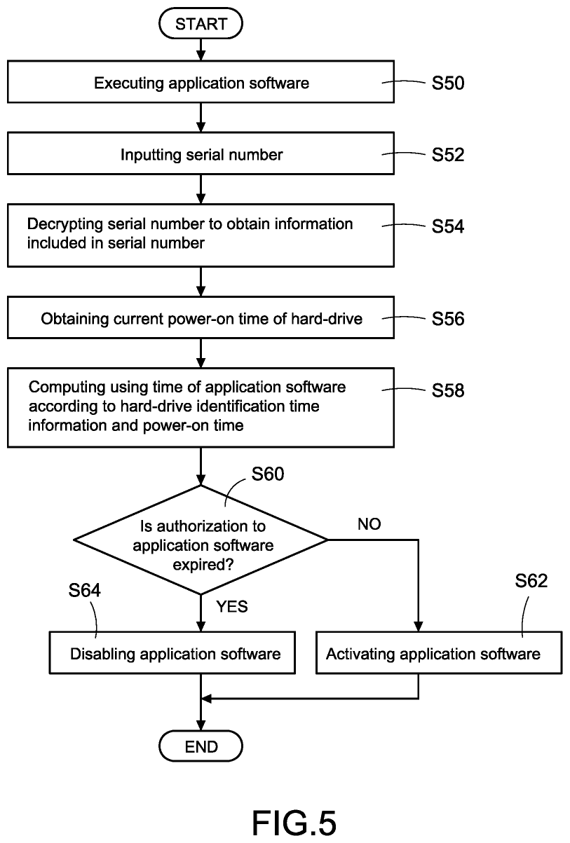

Please refer to FIG. 1 through FIG. 5, wherein FIG. 5 is a flowchart for a verification of an embodiment according to this disclosure. In this embodiment, the electronic device 1 first executes the application software 121 through the processor 11 (step S50). If the serial number of the application software 121 is not yet inputted, the application software 121 displays a serial number input window (not shown in figures) through the display unit 15, and the user may input the serial number received from the publish-end server 2 to the application software 121 (step S52).

In another embodiment, the application software 121 may start waiting automatically after generating the application code 33 and transmitting the application code 33 to the publish-end server 2, and the application software 121 may obtain the serial number automatically from the electronic device 1 after the electronic device 1 receives the serial number from the publish-end server 2. In this embodiment, the application software 121 may not have to display the serial number input window, and the user may not have to manually input the serial number.

After the step S52, the application software 121 decrypts the received serial number to obtain the information included in the serial number (step S54). In one of the exemplary embodiments, the serial number at least records the requested using term 32 of the application software 121, and the hard-drive identification time information of the hard-drive 12 of the electronic device 1 recorded at the time the user requested for the serial number.

After the step S54, the application software 121 further requests the electronic device 1 to obtain the power-on time of the hard-drive 12 of the electronic device 1 (step S56) at the very time. After the power-on time of the hard-drive 12 is obtained, the application software 121 computes a using time of the application software 121 in the electronic device 1 according to the hard-drive identification time information in the serial number and the power-on time (step S58).

In particular, the hard-drive identification time information included in the serial number indicates the power-on hours of the hard-drive 12 recorded in the S.M.A.R.T data of the electronic device 1 at the time the user requested for the serial number (referred to as a first power-on hours below). The power-on time provided by the electronic device 1 in the step S56 indicates the power-on hours of the hard-drive 12 recorded in the S.M.A.R.T data of the electronic device 1 at the time the application software 121 requested for the power-on time (referred to as the second power-on hours below). In the step S58, the application software 121 subtracts the first power-on hours from the second power-on hours to compute the using time of the application software 121 being used in the electronic device 1.

After the step S58, the application software 121 determines whether an authorization to the application software 121 is expired based on the using time and the requested using term 32 (step S60). For example, if the using time is equal to or longer than the requested using term 32, the application software 121 may determine that the authorization to the application software 121 is expired. In the step S60, the application software 121 may activate the application software 121 when the authorization is determined to be unexpired (step S62), and may disable the application software 121 when the authorization is determined to be expired (step S64).

A first time point that the application software 121 requests the electronic device 1 for the power-on time to the hard-drive 12 must be later than a second time point that the user requests for the serial number, hence a positive number must be obtained after subtracting the first power-on hours from the second power-on hours. Moreover, internal data of the electronic device 1 may be modified intentionally by the people with bad intentions and may be easily erroneous due to the technical problem. Thus, when the application software 121 computes the using time and finds that the result of subtracting the first power-on hours from the second power-on hours is a negative number (i.e., the second power-on hours is less than the first power-on hours), the application software 121 may directly determine that the authorization is expired and application software 121 is disabled.

As mentioned above, the content of the serial number obtained by the application software 121 corresponds to the content of the application code 33 generated by the application software 121. Therefore, apart from computing the using time and determining whether the authorization is expired according to the using time, the application software 121 may also perform the offline verification action according to other data based on the real situation.

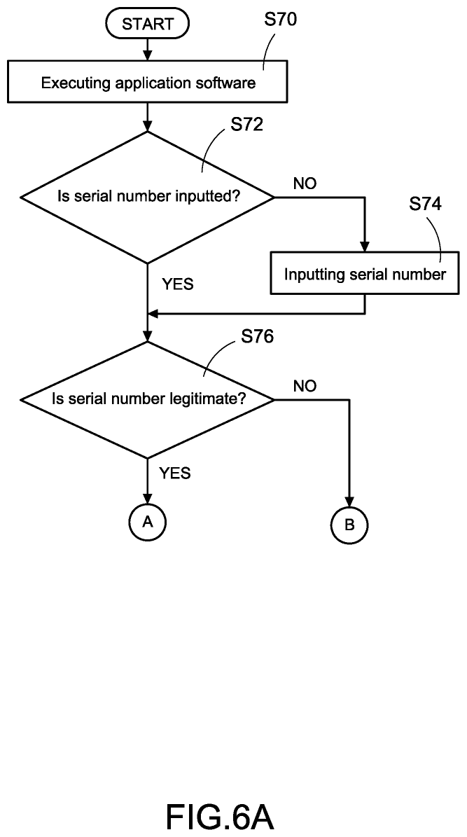

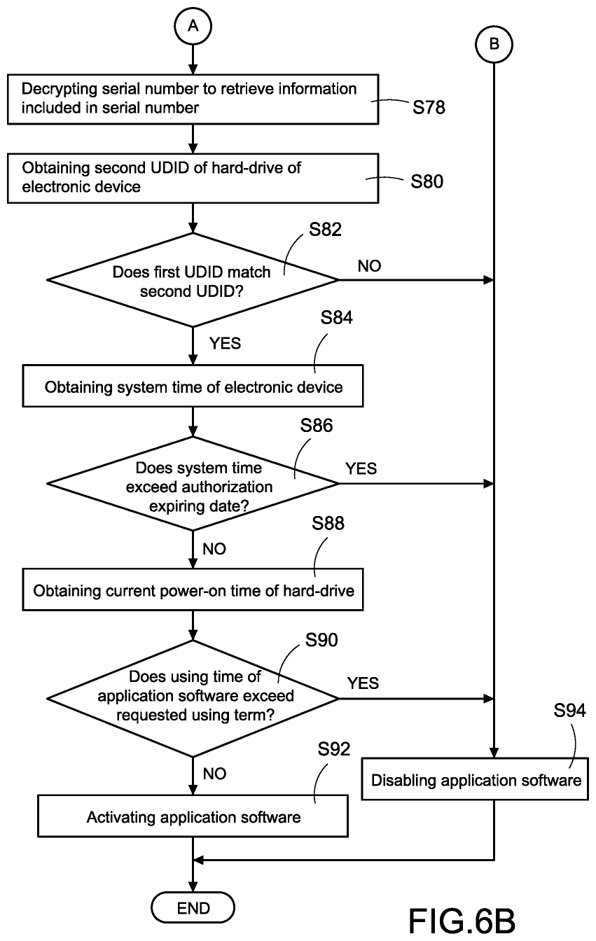

Please refer to FIG. 1 through FIG. 6A and FIG. 6B, wherein FIG. 6A and FIG. 6B are flowcharts respectively showing a first part of the verification and a second part of the verification according to this disclosure. In this embodiment, the electronic device 1 first executes the application software 121 through the processor 11 (step S70). Next, the application software 121 determines whether a serial number is inputted (step S72). If the serial number is not received yet, the application software 121 may receive the serial number inputted by the user through a serial number input window, or automatically obtain the serial number from the electronic device 1 when the serial number is transmitted from the publish-end server 2 to the electronic device 1 (step S74).

It should be mentioned that the serial number needs to be inputted only when the application software 121 is executed for the first time. Once the serial number is inputted, the serial number may be recorded by the application software 121, and the user does not have to input the serial number again in the following procedures.

After the serial number is received, the application software 121 determines whether the serial number is legitimate (step S76), and disables the application software 121 when the serial number is determined to be illegitimate (step S94). For example, in the step S94, the application software 121 may be turned off immediately, or the electronic device 1 may be blocked from the authority of operating the application software 121. In one of the exemplary embodiments, the application software 121 records the encrypted algorithm used by the publish-end server 2 in the step S40 as shown in FIG. 4. In the step S76, the application software 121 determines the serial number is illegitimate if the serial number cannot be correctly decrypted by the application software 121 through the same algorithm.

The above description is only one of the exemplary embodiments of this disclosure. In another embodiment, the application software 121 may directly decrypt the serial number after receiving the serial number and skip the determination for the legitimacy of the serial number.

Next, the application software 121 decrypts the serial number to retrieve the information included in the serial number (step S78).

In one of the exemplary embodiments, the application software 121 uses the UDID of the hard-drive 12 of the electronic device 1 (referred to as a first UDID) as one of the parameters for generating the application code 33 in the step S20 as shown in FIG. 2. Similarly, the publish-end server 2 uses the first UDID as one of the parameters for generating the serial number in the step S40 as shown in FIG. 4. Therefore, after the serial number is decrypted, the application software 121 may obtain the first UDID. In this embodiment, the first UDID is used to indicate the identity of the hard-drive 12 used by the electronic device 1 at the time the user requested for the serial number.

In this embodiment, the application software 121 requests the electronic device 1 for the UDID of the hard-drive 12 used by the electronic device 1 at the very time (referred to as a second UDID) (step S80), and the application software 121 further determines whether the first UDID matches the second UDID (step S82).

If the first UDID does not match the second UDID, it means that the electronic device 1 or the hard-drive 12 of the electronic device 1 is changed. Under such circumstance, the application software 121 may execute the step S94 as mentioned above to disable the application software 121. On the contrary, if the first UDID matches the second UDID, it means that the hardware is not changed, and the application software 121 may proceed to perform the rest of the verification action.

In one of the exemplary embodiments, the publish-end server 2 uses the application date as one of the parameters for generating the serial number in the step S40 as shown in FIG. 4. After the serial number is decrypted, the application software 121 may retrieve the application date. In this embodiment, the application date indicates the time point that the user requests for the serial number.

In this embodiment, the application software 121 requests the electronic device 1 to obtain the system time of the electronic device 1 (step S84). The system time may be, for example, OS time or BIOS time of the electronic device 1, but not limited thereto. Next, the application software 121 computes an authorization expiring date of the application software 121 according to the application date and the requested using term 32 retrieved from the serial number, and determines whether the system time of the electronic device 1 exceeds the authorization expiring date (step S86).

For instance, the application date may be an absolute date, such as Jan. 1, 2020, and the requested using term 32 may be a length of time, such as two years. Therefore, the application software 121 may compute the authorization expiring date as Jan. 1, 2022. In the step S86, the authorization to the application software 121 may be considered to be unexpired if the system time of the electronic device 1 is not yet beyond the authorization expiring date.

However, the system time of the electronic device 1 may easily be modified as discussed above. For the sake of safety, the application software 121 of this disclosure may perform further verification actions in addition to the comparison of the system time.

In another embodiment, the publish-end server 2 may obtain the application date in the step S38 as shown in FIG. 4, and then the publish-end server 2 may compute an authorization expiring date according to the application date and the requested using term 32. In the step S40 of FIG. 4, the publish-end server 2 uses the authorization expiring date as one of the parameters for generating the serial number. In this embodiment, the application software 121 may directly obtain the authorization expiring date after decrypting the serial number. As a result, after the system time of the electronic device 1 is obtained, the application software 121 may directly execute the step S86 as shown in FIG. 6B to determine whether the authorization to the application software 121 is expired without performing additional computation procedures.

In the aforementioned embodiment, the requested using term 32 selected by the user when applying the serial number is a length of time such as one year, two years, etc. (as shown in FIG. 3A). In another embodiment, the user may directly select an exact authorization expiring date as the requested using term 32. In such an embodiment, neither the publish-end server 2 nor the application software 121 needs to perform additional computation procedures to compute the authorization expiring date, hence the execution speed of the verification action may be improved.

Next, the application software 121 requests the electronic device 1 to obtain the power-on time of the hard-drive 12 of the electronic device 1 at the very time (step S88). Next, the application software 121 computes the using time of the application software 121 in the electronic device 1 according to the power-on time and the hard-drive identification time information included in the serial number, and the application software 121 determines whether the using time exceeds the requested using term 32 included in the serial number (step S90).

Similarly, the hard-drive identification time information in this embodiment indicates a first power-on hours of the hard-drive 12 recorded in the S.M.A.R.T data of the electronic device 1 at the time the user requested for the serial number. The power-on time provided by the electronic device 1 in the step S88 indicates a second power-on hours of the hard-drive 12 recorded in the S.M.A.R.T data of the electronic device 1 at the time the application software 121 requested the electronic device 1 for the power-on time. In the step S90, the application software 121 subtracts the first power-on hours from the second power-on hours to compute the using time of the application software 121 in the electronic device 1.

If the using time is determined to be exceeding the requested using term 32 in the step S90, the application software 121 determines that the authorization to the application software 121 is expired and the application software 121 is disabled (step S94). If the using time is determined to be not exceeding the requested using term 32 in the step S90, the application software 121 determines that the authorization is unexpired and the application software 121 is allowed to be activated (step S92). In this embodiment, the application software 121 determines that the using time exceeds the requested using term 32 when the using time is greater than or equal to the requested using term 32, and determines that the using time does not exceed the requested using term 32 if the using time is less than the requested using term 32.

In another embodiment, the application software 121 may obtain the application date of the serial number and the requested using term 32 after decrypting the serial number. The requested using term 32 records a specific authorization expiring date (for example, Dec. 31, 2022). In this embodiment, the application software 121 may compute an inferred date (for example, the date at the very time) according to the application date (such as Jan. 1, 2020) and the using time (such as 9000 hours). In the step S90, the application software 121 may determine whether the inferred date is beyond the authorization expiring date, so as to determine whether the authorization to the application software 121 is expired. The above descriptions are only few embodiments of this disclosure, but not limited thereto.

By using the verification method discussed in this disclosure, an application software may verify the authorization by itself under the offline environments, thus a strong protection may be provided through relatively low cost, which benefits the software providers.

The above descriptions are only a part of the embodiments of this disclosure. Depending on the content of the application code generated by the application software 121, the publish-end server 2 as disclosed may generate the serial number for the verification action according to different data, the above discussed embodiments are not intended to limit the claimed scope of this disclosure.

As the skilled person will appreciate, various changes and modifications can be made to the described embodiment. It is intended to include all such variations, modifications and equivalents which fall within the scope of this disclosure, as defined in the accompanying claims.

What is claimed is:

1. A verifying method for software authorization under an offline environment, being incorporated with an electronic device comprising a processor and a hard-drive, the verifying method comprising:
a) executing an application software by the processor;
b) obtaining a serial number and inputting the serial number to the application software;
c) retrieving information included in the serial number, wherein the serial number at least comprises a requested using term of the application software and a hard-drive identification time information of the hard-drive recorded at the time the serial number being applied;
d) obtaining a power-on time of the hard-drive;
e) computing a using time of the application software in the electronic device according to the hard-drive identification time information and the power-on time;
f) determining whether an authorization to the application software is expired based on the using time and the requested using term; and
g) disabling the application software if the authorization to the application software is expired.

2. The verifying method in claim 1, wherein the hard-drive identification time information comprises a first power-on hours of the hard-drive recorded in a self-monitoring analysis and reporting technology (S.M.A.R.T) data of the electronic device at the time the serial number being applied, the power-on time comprises a second power-on hours of the hard-drive recorded in the S.M.A.R.T data of the electronic device, wherein the step e) further comprises computing the using time by subtracting the first power-on hours from the second power-on hours.

3. The verifying method in claim 2, wherein the serial number further comprises an application date of the serial number, the requested using term comprises an authorization expiring date, the step f) further comprises determining whether the authorization to the application software is expired according to the application date, the using time, and the authorization expiring date.

4. The verifying method in claim 2, wherein the serial number comprises a first unique device identification (UDID), and the method further comprises following steps after the step c):
c11) obtaining a second UDID of the hard-drive;
c12) determining whether the first UDID matches the second UDID; and
c13) disabling the application software if the first UDID unmatches the second UDID.

5. The verifying method in claim 2, wherein the serial number further comprises an authorization expiring date of the application software, and the method further comprises following steps after the step c):
c21) obtaining a system time of the electronic device;
c22) determining whether the system time is beyond the authorization expiring date; and
c23) disabling the application software if the system time is beyond the authorization expiring date.

6. The verifying method in claim 2, further comprising following steps after the step c):
c31) determining whether the serial number is legitimate; and
c32) disabling the application software if the serial number is illegitimate, wherein the serial number is determined to be illegitimate when the application software is unable to decrypt the serial number correctly.

7. The verifying method in claim 2, wherein the electronic device comprises a transmission unit, the step b) further comprises receiving the serial number generated and transmitted by a publish-end server through the transmission unit.

8. The verifying method in claim 7, further comprising following steps after the step a):
a01) obtaining an applicant information, the requested using term, and a hard-drive information of the hard-drive of the electronic device when the serial number of the application software needs to be applied, wherein the hard-drive information at least comprises the hard-drive identification time information;
a02) performing a first encrypted computation for the applicant information, the requested using term, and the hard-drive information to generate an application code; and
a03) transmitting the application code to the publish-end server through the transmission unit, wherein the publish-end server generates the serial number based on the application code.

9. The verifying method in claim 8, further comprising following steps after the step a):
a04) receiving the application code by the publish-end server;
a05) decrypting the application code to retrieve the applicant information, the requested using term, and the hard-drive information;
a06) recording the applicant information;
a07) performing a second encrypted computation for the requested using term and the hard-drive information to generate the serial number; and
a08) transmitting the serial number to the electronic device.

10. The verifying method in claim 9, wherein the hard-drive information comprises a first unique device identification (UDID) of the hard-drive.

11. The verifying method in claim 9, further comprising a step a007) before the step a07, the step a007) comprising: obtaining a system time of the publish-end server as an application date of the serial number; wherein the step a07) further comprises performing the second encrypted computation for the requested using term, the application date, and the hard-drive information to generate the serial number.

12. The verifying method in claim 11, wherein the step a07) further comprises:
a071) computing an authorization expiring date according to the application date and the requested using term; and
a072) performing the second encrypted computation for the requested using term, the authorization expiring date, and the hard-drive information to generate the serial number.

13. A verifying method for software authorization under an offline environment, being incorporated with an electronic device comprising a processor and a hard-drive, the verifying method comprising:
a) executing an application software by the processor;
b) obtaining a serial number by the application software;
c) decrypting the serial number by the application software to at least retrieve an application date of the serial number, an authorization expiring date of the application software, a first unique device identification (UDID) and a first power-on hours of the hard-drive recorded at the time the serial number being applied;
d) obtaining a second UDID of the hard-drive used by the electronic device;
e) disabling the application software when the first UDID unmatching the second UDID is determined;
f) obtaining a system time of the electronic device;
g) disabling the application software when the system time exceeding the authorization expiring date is determined;
h) obtaining a second power-on hours of the hard-drive;
i) computing a using time of the application software in the electronic device according to the first power-on hours and the second power-on hours;
j) computing an inferred date according to the application date and the using time; and
k) disabling the application software when the inferred date exceeding the authorization expiring date is determined.

14. The verifying method in claim 13, further comprising following steps after the step a):
a01) obtaining an applicant information, a requested using term, the first power-on hours, and the first UDID through the electronic device when an application request for the serial number is provided;
a02) performing a first encrypted computation for the applicant information, the requested using term, the first power-on hours, and the first UDID to generate an application code; and
a03) transmitting the application code to a publish-end server, wherein the publish-end server generates the serial number based on the application code.

15. The verifying method in claim 14, further comprising following steps after the step a):
a04) receiving the application code by the publish-end server;
a05) decrypting the application code to retrieve the applicant information, the requested using term, the first power-on hours, and the first UDID;
a06) recording the applicant information;
a07) obtaining a system time of the publish-end server as the application date of the serial number;
a08) computing the authorization expiring date according to the application date and the requested using term;
a09) performing a second encrypted computation for the application date, the authorization expiring date, the first UDID, and the first power-on hours to generate the serial number, wherein the second encrypted computation is different from the first encrypted computation; and
a10) transmitting the serial number to the electronic device.
